(19) United States
(12) Patent Application Publication
(10) Pub. No.: US 2024/0040970 A1
(43) Pub. Date: Feb. 8, 2024

(54) TRAY SYSTEM FOR PLANT CULTIVATION

(71) Applicant: Integrated Hydro Solutions Inc., Kelseyville, CA (US)

(72) Inventors: Leigh Michael Zalusky, Cobb, CA (US); Gregory Lewis Panella, Finley, CA (US)

(21) Appl. No.: 18/230,573

(22) Filed: Aug. 4, 2023

Related U.S. Application Data
(60) Provisional application No. 63/395,015, filed on Aug. 4, 2022.

(51) Int. Cl. A01G 9/02

(52) U.S. Cl. CPC A01G 9/022; A01G 9/027

(57) ABSTRACT

A tray for a vertical growing system for growing plants having opposed first and second side walls, a first open end and second open end opposed to the first end defining a perimeter of the tray; and a raised region disposed within the perimeter of the tray wherein the first end comprises a male extension and the second end comprises a female extension; wherein the male extension and female extension are configured to snap together between two adjacent trays.

### CROSS-REFERENCE TO RELATED APPLICATIONS

The present application claims priority to U.S. Provisional Application No. 63/395,015, filed Aug. 4, 2022, the disclosure of which is incorporated herein by reference in its entirety.

### TECHNOLOGICAL FIELD

This disclosure relates to a tray system for use in horticultural or agricultural operations.

### BACKGROUND

Air stratification and excess water/nutrient collection are two problems associated with enclosed vertical agricultural operations. Air stratification can occur when insufficient ventilation is present, and can be especially problematic for the lower levels of racked operations where the canopy of one level of crop tends to prevent the downward circulation of air from vents or fans, which are typically present on the ceiling. Stratification is the layering of air due to density variations caused by temperature, humidity, carbon dioxide depletion etc. and is detrimental to the health of the crops being grown.

Enclosed vertical agricultural operations require that the racking systems provide a method of collecting and consolidating excess water and nutrients draining from the individual growing containers. Fluid that is not consolidated and removed from the operation can foster the growth of mold, fungus and other organisms detrimental to the health of the crops.

Current conventional solutions depend on a combination of technologies to implement drainage and de-stratification using separate trays and combinations of duct work and fans mounted below the growing trays, interfering with the positioning of lighting and potentially decreasing possible vertical density.

### SUMMARY OF THE DISCLOSED SUBJECT MATTER

Provided is a tray and duct system for plant cultivation.

In a first aspect, the system comprises a tray comprising opposed first and second side walls, a first open end and second open end opposed to the first end defining a perimeter of the tray, and a raised region disposed within the perimeter of the tray wherein the first end comprises a male extension and the second end comprises a female extension; wherein the male extension and female extension are configured to snap together between two adjacent trays.

Embodiments of the tray include the following alone or in any combination.

At least a portion of an outer surface of a male extension on a first tray may be configured to slidingly engage at least a portion of an inner surface of a female extension on a second adjacent tray.

The female extension may comprise a locking channel configured to engage a complementary ridge on the male extension.

The raised region of the tray may comprise a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges.

The plurality of alternating parallel ridges may comprise top surfaces defining a level plane for supporting one or more individual growing containers for containing growth medium and plants, and the plurality of valleys slope downward from a peak to a gutter proximate to the perimeter of the tray, the one or more of the plurality of valleys are in fluid communication with the gutter for channeling fluid collected into the gutter.

At least a portion of the first side wall may be configured to engage a top of a first elongate side support member and at least a portion of the second side wall is configured to engage a top of a second elongate side support member.

At least a portion of the first side wall is engaged with the top of the first elongate side support member and at least a portion of the second side wall is engaged with the top of the second elongate side support member; and a bottom panel is engaged between the first and second elongate side members; wherein the tray, the first and second elongate side members and the bottom panel define an air passage.

The raised region of the tray may comprise a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges.

The bottom panel may optionally comprise a plurality of orifices to direct air from the air passage.

The air passage may comprise an elongated duct assembly having a first end in fluid communication with an outlet opening of a fan assembly, a second end opposed to the first end configured to be either closed or in fluid communication with a second duct assembly, and a plurality of orifices or a plurality of holes in the one or more air passages to distribute air out of the one or more air passages.

The plurality of orifices or the plurality of holes may be configured to direct air from the duct assembly to above the duct assembly; or direct air from the duct assembly to below the duct assembly; or direct air from the duct assembly to above and below the duct assembly.

A second aspect provides a duct assembly comprising a tray as described above including any of the aforementioned embodiments wherein at least a portion of the first side wall is engaged with the top of the first elongate side support member and at least a portion of the second side wall is engaged with the top of the second elongate side support member; and a bottom panel is engaged between the first and second elongate side members; wherein the tray, the first and second elongate side members and the bottom panel define one or more air passages.

Embodiments of the duct assembly include the following alone or in any combination.

At least a portion of an outer surface of a male extension on a first tray may be configured to slidingly engage at least a portion of an inner surface of a female extension on a second adjacent tray.

The female extension may comprise a locking channel configured to engage a complementary ridge on the male extension.

The duct assembly may further comprise a center support member engaged to a first and second bottom panel and the bottom surface of the tray to define two air passages in the duct assembly.

The raised region of the tray may comprises a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges.

The plurality of alternating parallel ridges may comprise top surfaces defining a level plane for supporting one or more individual growing containers for containing growth medium and plants, and the plurality of valleys slope downward from a peak to the gutter proximate to the perimeter of the tray, the one or more of the plurality of valleys are in fluid communication with the gutter for channeling fluid collected into the gutter.

The raised region of the tray may comprise one or more of a plurality of holes in one or more of the plurality of ridges.

The bottom panel may comprise a plurality of orifices to direct air from the air passage.

The air passage may comprise a first end in fluid communication with an outlet opening of a fan assembly, a second end opposed to the first end configured to be either closed or in fluid communication with a second duct assembly, and a plurality of orifices or a plurality of holes in the one or more air passages to distribute air out of the one or more air passages.

The plurality of orifices or the plurality of holes may be configured to direct air from the duct assembly to above the duct assembly; or direct air from the duct assembly to below the duct assembly; or direct air from the duct assembly to above and below the duct assembly.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows a top plan view of a tray for a ventilation system according to an embodiment of the disclosed subject matter.

FIG. 2A shows a top plan view of two adjacent trays for a ventilation system according to an embodiment of the disclosed subject matter.

FIGS. 2B and 2C show perspectives view of two adjacent trays for a ventilation system according to an embodiment of the disclosed subject matter.

FIG. 2D shows a side close-up view of two adjacent trays for a ventilation system according to an embodiment of the disclosed subject matter.

FIG. 3A shows an exploded end perspective view of two adjacent trays of a duct assembly system according to an embodiment of the disclosed subject matter.

FIG. 3B shows an exploded side perspective view of two adjacent trays of a duct assembly system according to an embodiment of the disclosed subject matter.

FIG. 4A shows a cross-section view of a side support member of a duct assembly system according to an embodiment of the disclosed subject matter.

FIG. 4B shows a cross-section view of a center support member of a duct assembly system according to an embodiment of the disclosed subject matter.

FIG. 4C shows a close-up end view of a tray engaged to a side support member of a duct assembly system according to an embodiment of the disclosed subject matter.

FIG. 5 shows a perspective view of a duct assembly system engaged to a vertical rack system according to an embodiment of the disclosed subject matter.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

Disclosed herein is a tray for a duct system for cultivating plants.

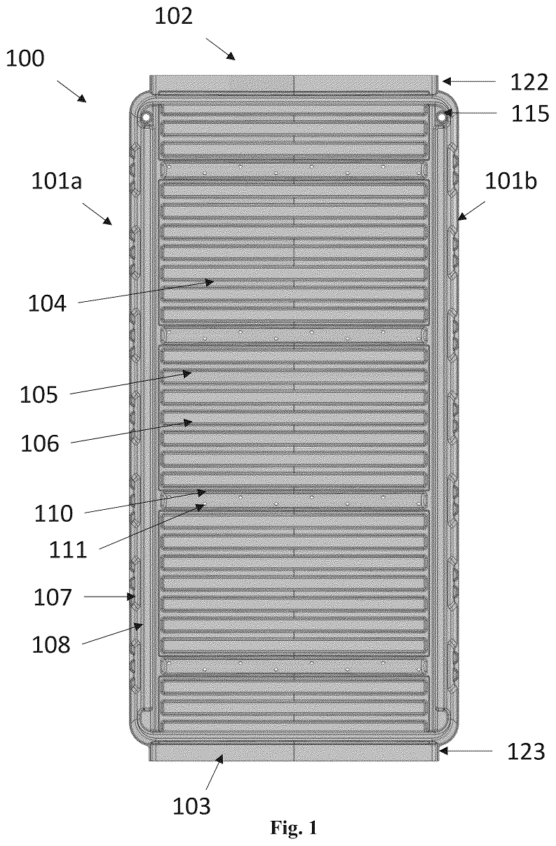

FIG. 1 shows a top view of an embodiment of an exemplary tray 100. The tray comprises opposed side walls 101a and 101b, opposed first end 102 and second ends 103 defining a perimeter of the tray, and a raised region 104 disposed within the perimeter of the tray. In embodiments, the at least a portion of side walls 101a and 101b and ends 102 and 103, in combination with gutter 107, are configured with a convex upward boundary 108 that provides an engagement surface to a lower portion of a duct assembly as described further below, wherein the tray defines an upper portion of the duct assembly. In embodiments, the side walls 101a and 101b of the tray may extend below the raised region to support the raised region above the duct assembly. The side walls may also provide support to the tray when it is not disposed on the duct assembly. In other embodiments, the side walls may not extend below the lowest surface of raised region, but extend downward far enough to define boundary 108. The ends 102 and 103 are open to allow air to flow below the raised region of the tray.

Preferably, the raised region of the tray comprises a plurality of alternating parallel ridges 105 disposed between the side walls and a plurality of valleys 106 formed between adjacent ridges of the plurality of ridges, wherein one or more of the plurality of valleys 106 are in fluid communication with gutter 107; and optionally one or more of a plurality of holes 111 in one or more of the plurality of ridges. The valleys 106 slope toward the gutter 107 so that water on the raised region of the tray flows to the gutter. In the embodiment shown, a subset of the ridges comprises a plurality of ridges 110 that comprise holes 111. In notable embodiments, the ridges 110 have top surfaces higher than the top surfaces of the ridges 105 to prevent water from above to pass through the holes 111. The plurality of holes 111, when present, are in fluid communication with the duct assembly to direct air from the duct assembly to above the tray 100.

In the embodiment shown, the plurality of alternating parallel ridges 105 comprise top surfaces defining a level plane for supporting one or more individual growing containers for containing growth medium and plants, and the plurality of valleys 106 slope downward from a peak to the gutter 107 proximate to the perimeter of the tray, the one or more of the plurality of valleys are in fluid communication with the gutter for channeling fluid collected into the gutter. Notably, the gutter may be configured to be in fluid communication with a fluid drainage system via hole(s) 115. The slope of the valleys from the high point at the center of the tray to the junction of the valley and the gutter may be about 0.25 to 3 degrees down from horizontal, such as 1 to 3 degrees, for example 1 degree. A fitting, such as a hose barb, may be disposed on the bottom of the tray at each hole 115 to allow fluid communication from the gutter 107 to a drainage system via a hose or tubing attached to the fitting. Positions for holes 111 and 115 may be molded into the tray as punch-out pieces that can be removed as desired to open the holes 111 and/or 115.

In other embodiments the valleys may slope from a first side of tray to the opposed second side to a single gutter proximate to the second side in fluid communication with the valleys to collect fluid from the top of tray. In these embodiments, the duct assembly discussed below would have a cross-section complementary to the slope of the valleys wherein the top of duct assembly has a slope equivalent to the slope of valleys.

In other embodiments the valleys may slope down from a first side of the tray and a second side of the tray to a single gutter proximate to the central region of the raised portion of the tray in fluid communication with the valleys to collect fluid from the top of tray. In these embodiments, the duct assembly would have a cross-section complementary to the slope of the valleys wherein the top of duct assembly has a slope equivalent to the slope of valleys.

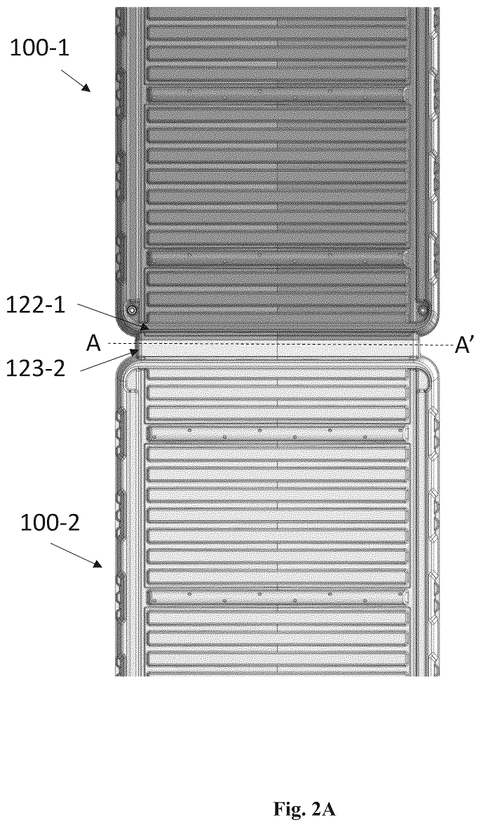

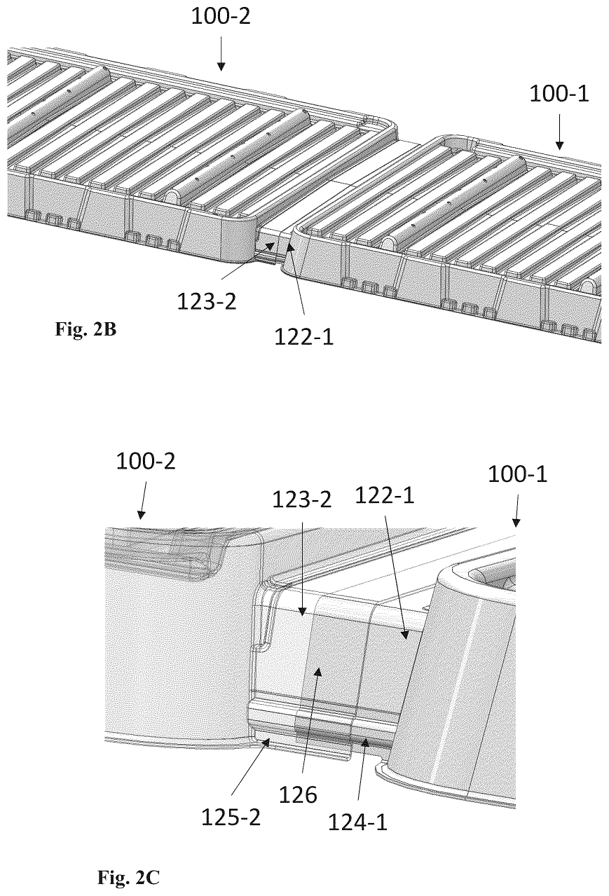

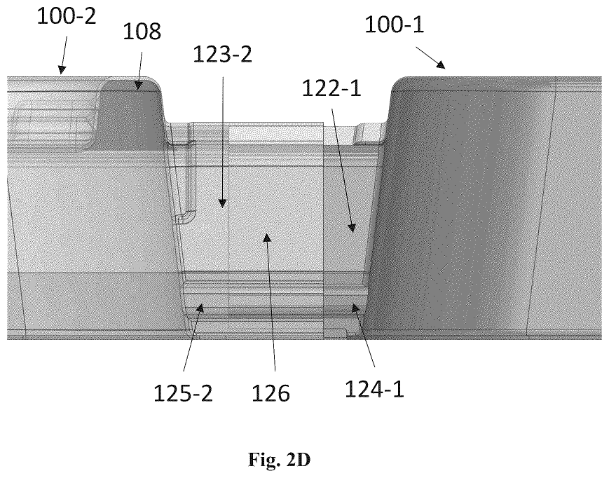

Each tray 100 incorporates a male extension 122 on end 102 and female extension 123 on end 103, configured to snap together to provide an upper portion of an air passage between two adjacent trays, as shown in an overhead plan view in FIG. 2A and overhead perspective view in FIG. 2B. The extensions preferably are molded with the rest of the tray in a single molding. The outer surface of male extension 122-1 (partially obscured) on a first tray 100-1 is configured to engage the inner surface of female extension 123-2 on a second adjacent tray 100-2. The extensions form a sliding connection between successive trays, eliminating the need for a coupling panel in the duct between the trays. The sliding connection allows trays be positioned between the rack uprights of various manufacturers' racks without modification. This joint requires no additional seals to be air tight, as the overlap and minimal gap between the male extension 102-1 and female extension 103-2 provides an acceptable seal given the air volumes delivered through the ventilation system. Depending on the length of the ducting assembly desired, a plurality of trays 100 can be placed end-to-end and joined together by the joints formed by their respective extensions 122 and 123.

FIG. 2C shows a close-up perspective view and FIG. 2D shows a close-up side view of the extensions 122-1 and 123-2 on adjacent trays 100-1 and 100-2. Tray 100-2 is shown as transparent, allowing extension 122-1 to be visible behind extension 123-2. A locking feature is included to retain the female side of the tray above and around the male side of the mating tray. In the embodiment shown in FIG. 2C, the locking feature comprises a convex ridge 124-1 on male extension 122-1 with an outer surface configured to engage the inner surface of a concave channel 125-2 on female extension 123-2. The overlap between male extension 122-1 and female extension 123-2 is indicated by reference number 126. Also shown in FIG. 2D is the convex outer surface of boundary 108.

Trays 100 are configured to engage with lower duct assembly members to define an elongated duct assembly comprising one or more air passages, the duct assembly having a first end in fluid communication with an outlet opening of a fan assembly, a second end opposed to the first end configured to be either closed or in fluid communication with a second duct assembly member, and a plurality of orifices in the one or more air passages to distribute air out of the one or more air passages. Notably, the duct system comprises a plurality of orifices configured to direct air from the duct assembly to above the duct assembly; or direct air from the duct assembly to below the duct assembly; or direct air from the duct assembly to above and below the duct assembly.

The bottom surface of the raised region of the tray 100 comprises the top panel of the duct assembly. Optionally, thin adhesive backed sheets may be added to the underside of the tray to improve performance by reducing duct turbulence inside the duct. The adhesive backed sheets may be adhesively attached to the bottom surface of the valleys in the raised portion of the tray. In embodiments, the adhesive backed sheets may cover a significant part of the underside of the tray. Notably, the sheets may not cover the bottom of the ridges 110, allowing air to pass from the duct into the ridges 110 and out holes 111 in tray 100. In other embodiments, the sheets may cover the bottom of the ridges 810, preventing air from passing from the duct into the ridges 110 and out holes 111 in tray 100.

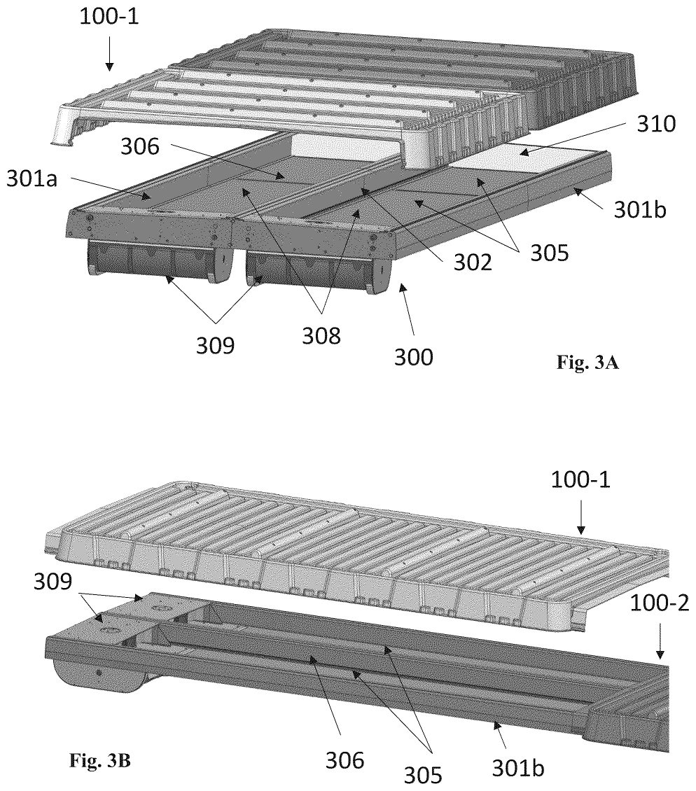

FIG. 3A shows a top perspective exploded end view of an exemplary embodiment of a duct assembly. FIG. 3B shows a top perspective exploded side view of the exemplary embodiment of a duct assembly. In the duct assembly, the bottom surfaces of trays 100-1 and 100-2 comprise the top of the duct assembly and overlie the bottom of the duct assembly 300. Because the trays 100 comprise the top of the duct system 300, the bottom of the duct system can be configured as a trough, comprising side members 301a and 301b and bottom panels 305. Optionally, as shown in this embodiment, a center member 302 may be included. In the embodiment shown in FIGS. 3A and 3B, the exemplary duct assembly 300 comprises one or more trays 100 that form the top of the duct assembly, flat bottom panels 305 that form the bottom of the duct assembly 300, an optional center support member 302 and side support members 301a and 301b. The trays 100 are configured to rest on the support members 301a, 301b and 302, which provide side walls of the one or more air passages 308 in the duct assembly bounded by trays 100, support members 301a, 301b and 302 (when present) and bottom panels 305. Bottom panels 305 are disposed between the center member 302 (if present) and respective side members 301a and 301b. Bottom panels 305 may optionally comprise a plurality of openings to distribute air below the duct. Bottom panels 305 may be made from polymer, composite or metal. Preferably the duct assembly panels can be made of plastics such as PVC, ABS, ASA, polycarbonate, polyethylene, etc. Notably, expanded PVC can be used due to its low cost and stiffness.

To provide adequate support for a tray placed over the lower duct and plant containers thereon, the support members may be typically fabricated from a variety of materials such as stainless steel, aluminum, alloys or carbon composites, etc. Notably, the support members are configured to be elongate with a consistent cross-section along their length, allowing for their fabrication as extrusions. Preferably, the center and side support members are aluminum extrusions.

As shown in FIGS. 3A and 3B, the duct assembly 300 is configured to be engaged to a fan assembly 309 at a first end. The fan assembly 309 is configured to drive ambient air through the air passages 308 and out holes 111 in tray 100 and/or holes in bottom panels 305. A closure 310 at a second end opposite the fan assembly 309 blocks air flow out the second end of the duct assembly so air flows out of the holes 111 and/or holes in bottom panels 305.

In some embodiments the bottom panels 305 may comprise a plurality of holes or orifices (not shown) to allow air to be distributed from the fan assembly through the ducts and onto plants below the tray system in a vertical growing system. The orifices may be round, oval shaped, rectangular, slotted etc. In other embodiments the bottom panels 805 do not comprise orifices and air cannot exit from the bottom of the duct assembly. The distribution of orifices in bottom panels 305 may be based on the desired flow capacity of the blowing system. Seals 306 may link flat panels 305 end-to-end in an extended duct assembly comprising a plurality of flat panels.

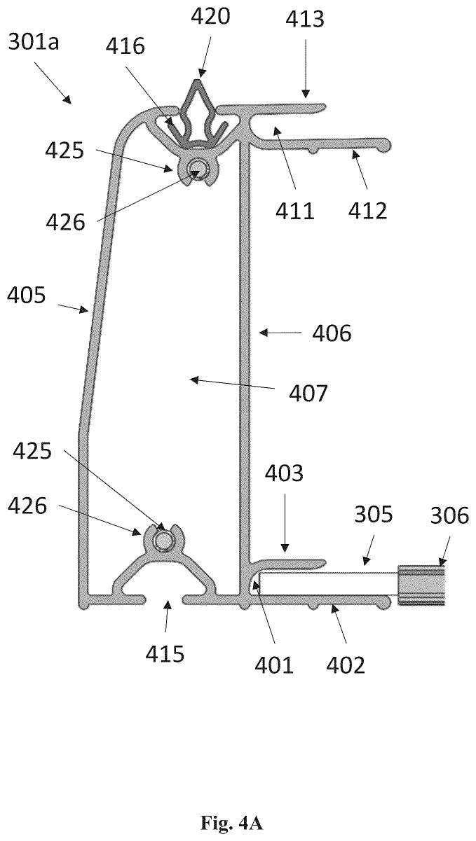

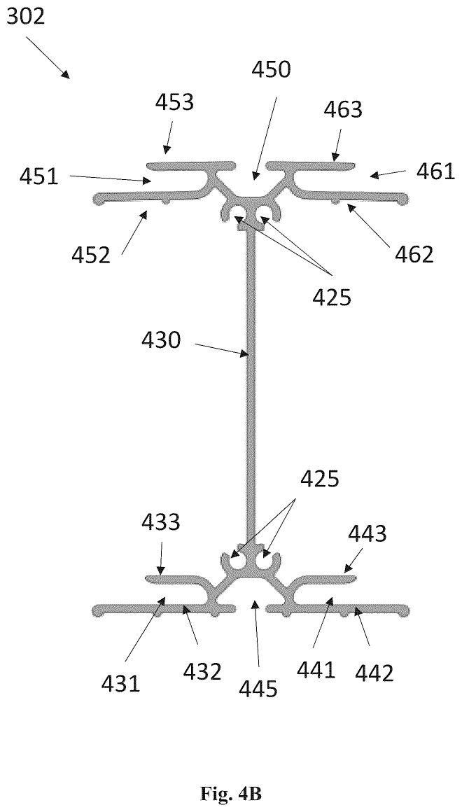

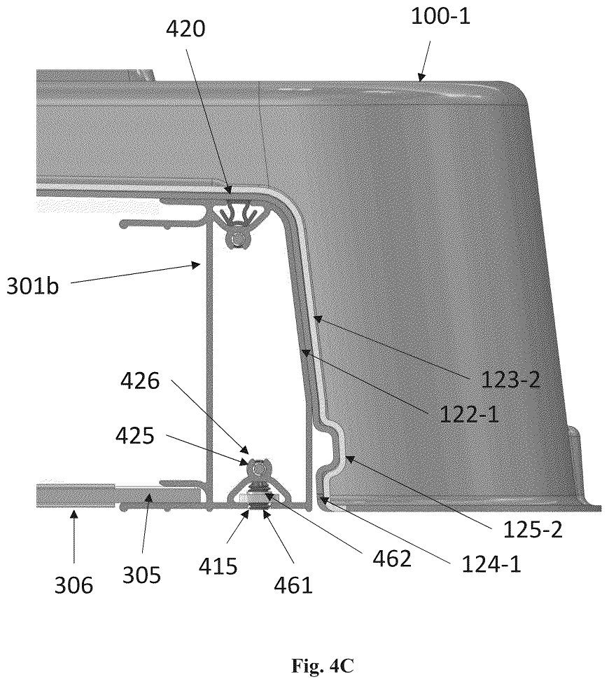

FIG. 4A shows a cross-section view of an exemplary embodiment of a first side support member 301a. It can be appreciated that the second side support member 301b may have the same cross section as 301a, but is deployed in the duct system in a mirror image of 301a. In the embodiment shown in FIG. 4A, the first and second elongate side support members 301a and 301b each comprise a generally triangular or trapezoidal cross-section comprising (i) a top section configured to support the bottom of each of the valleys 106 proximate to their junction with gutter 107, (ii) a middle lumen section, and (iii) a bottom section configured to connect with a bottom duct panel 305. In the embodiment illustrated in FIG. 4A, a first edge of the bottom duct panel 305 is attached to side support members 301a preferably by insertion into slot 401 formed by shelf 402 and flange 403 at the bottom of the side support member 301a.

First bar 405 may be configured to join the top section and the bottom section and is configured to support the tray 100 proximate to the region of the gutter 107. As shown, bar 405 may be sloped and curve toward the top and bottom sections, but that is not limiting. Second bar 406 may be configured to be vertical, also not limiting, and bounds one side of an air passage inside the duct assembly. The middle section comprises a lumen 407 bounded by a first bar 405, second bar 406 and the bottom section.

The top section comprises an open slot 416 in which a flexible seal or gasket 420 is inserted and runs the length of the supporting extrusions. In its uncompressed state, the seal extends above the top of to engage the bottom of tray 100. In alternate embodiments, the seal between the tray and support member extrusions may be accomplished by configuring the tray and extrusions with complementary locking features, without a separate sealing element (e.g. gasket 420).

The top section optionally comprises an upper shelf 412 and upper flange 413 each extending from one side of bar 406 defining slot 411. The upper flange may help support tray 100 when present. Alternatively or additively, slot 411 may provide an engagement channel for an alternative or additive linear seal to seal 420.

In the embodiment shown in FIG. 4B, the central support member 302 has a cross-section comprising (i) a top section configured to support the bottom of the peak of each of the valleys 105, (ii) a middle section comprising a bar 430, and (iii) a bottom section configured to engage ends of bottom panels 305.

The bottom section comprises a first lower shelf 432 extending from one side of bar 430 and a second lower shelf 442 extending from the opposed side of bar 430. The bottom section also comprises a first lower flange 433 extending from one side of bar 430 and a second lower flange 443 extending from the opposed side of bar 430. First lower shelf 432 and first lower flange 433 form a slot 431 to engage a first bottom panel 305. Second lower shelf 442 and second lower flange 443 form a slot 441 to engage a second bottom panel 305.

The top section is configured to engage and support the bottom surface of the center of tray 100. In embodiments, the top section may comprise a surface or surfaces having sloped areas having the same slope as the bottom surface of the tray. In the exemplary embodiment shown in FIG. 4B, the top section optionally comprises an open lumen 450 analogous to lumen 416 in side support member 301a, which can be used with an optional seal 420. In this embodiment, the top section optionally comprises a first upper shelf 451 extending from one side of bar 430 and a second upper shelf 462 extending from the opposed side of bar 430. In this embodiment, first upper flange 453 and second upper flange 463 support the bottom surface of tray 100, so upper shelves 452 and 462 are not necessary and may be eliminated in other embodiments. Alternatively or additively, slots 451 and 461 may provide engagement channels for an alternative or additive linear seal to seal 420.

In an alternative embodiment of center support member 302, bar 430 may be replaced by two bars. In this embodiment, the two bars may provide extra vertical support to the tray 100 and, in combination with the top section and the bottom section, define a lumen in center support member 302.

The bottom panels 305 are preferably releasably engaged with the support members 302, 301a and 301b so that the duct assembly can be disassembled to interchange bottom panels 305 to modify the air distribution out of the ducts to direct air above the tray system, below the tray system or both above and below the tray system. Disassembly also allows for easy cleaning and/or compact storage of the components of the duct assembly.

Notably, as shown in FIGS. 4A and 4B, the support members 302, 301a and 301b may also incorporate a feature (in the embodiments shown, “t-slots” 415 and 445) along their bottom surfaces to allow the installation of hooks or fittings to hold lighting and/or other equipment. Embodiments include those wherein the central support member 302 comprises a t-slot 445 extending the length of the central support member. Embodiments include those wherein the first and second elongate side support members 301a and 301b each comprises a t-slot 415 extending the length of their respective bottoms. The t-slots can also serve as a fastening feature between duct sections with the use of a connector that fits within the slot and bears between the inside of the slot and the top on each support member section. The t-slots may also be used to attach the duct assembly 300 to horizontal support members (e.g. cross members 503) on a rack system 500.

Lumens 407 in side support members 301a and 301b, and a lumen in an alternative embodiment of center support member 302 described above may be used as conduits to conduct fluids such as water or nutrient solutions to an irrigation system, or contain other components such as electrical wiring or tubing. For example but not limitation, lumens in side support members 301a and 301b may contain wires to supply power to lights mounted in t-slots 415 and a lumen in center support member 302 may conduct water to an irrigation system.

Optionally, as shown in FIGS. 4A and 4B, the support members 302, 301a and 301b may each also comprise one or more small lumens, depicted as open circles 425. Lumens 425 can also serve as a fastening feature between duct sections as discussed further below with the use of a connector 426 configured to fit within the lumens 425 and extend into the insides of lumens 425 on tray systems laid end-to-end. These may be used as alignment features with a pin spanning the two extrusion sections and precisely aligning the extrusions so that the t-slot clamp does not need to index the extrusions, only provide the mechanical fastening function.

FIG. 4C shows a cut-away end view of two trays engaged to side support member 301b, wherein the trays are cut along line A-A′ of FIG. 2A. FIG. 4C shows that at least a portion of the inner surface of female end 123-2 of tray 100-2 overlaps at least a portion of male end 122-1 of tray 100-1 with a tight but sliding fit. The overlap further comprises at least one locking feature. Molded-in locking channel 125-2 of tray 100-2 flexes over and locks down on complimentary ridge 123-1 on tray 100-1 allows the trays to slide but not lift off each other without sufficient force being applied. Notably, a second locking feature on the opposite side of the male and female ends is envisioned. When tray 100-1 overlays seal 420, it compresses under the weight of the tray and plants thereon, forming a seal between the tray and the support member 301b. The support member 301b, and similarly 301a and 302, may be attached to a horizontal member of a rack system using screw or bolt 461 and nut 462.

The tray 100 is configured to be used in conjunction with a racking system and fluidly coupled to rack-mounted distribution ducting components.

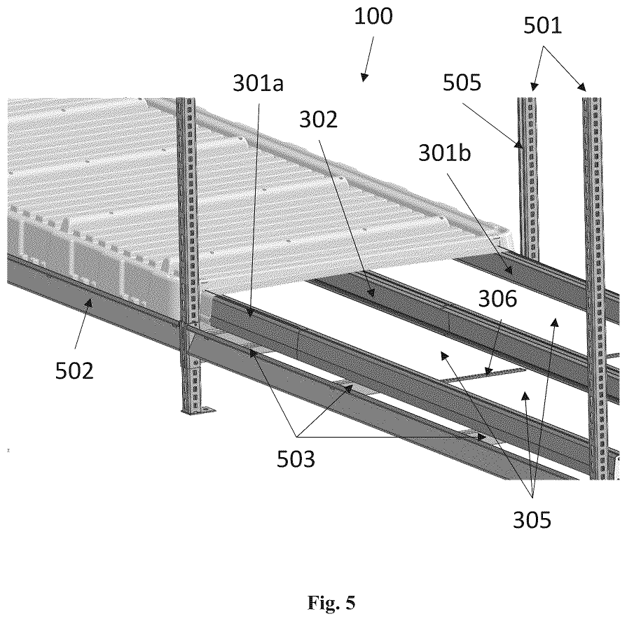

FIG. 5 shows a racking system 500 comprising a plurality of upright members 501, a plurality of horizontal members 502 and a plurality of horizontal cross members 503. Upright members 501 preferably comprise a plurality of holes or openings 505 that allow components to be mounted thereon, using fasteners such as bolts or clips. The plurality of holes 505 allows a user to selectively position members 502 and 503 at desirable levels or heights to grow plants in a vertical growing system. Ducting system 300 is installed on the rack system. Typically, the lower ducting components will be laid down first with the tray 100 positioned or disposed over the top of the lower duct components. In the embodiment shown, side support members 301a and 301b and center support member 302 are fastened to horizontal cross members 503, such as by using screws 461 and nuts 462. Bottom panels 305 are disposed between center member 302 and side members 301a and 301b. Seals 306 between panels 305 provide a continuous bottom boundary of air passage(s) of the duct assembly. As shown, optionally the joints between panels 305 may be staggered relative to the joints between trays 100. Side members 301a and 301b provide continuous side boundaries of the air passage. Trays 100 are disposed over the support members in contact with seals 420 on side members 301a and 301b to define the top boundary of the air passage. In embodiments, the system comprises one or more trays 100 to support plants and growing medium above the air passage of the duct assembly.

1. A tray for cultivating plants in a vertical growing system comprising:
opposed first and second side walls, a first open end and second open end opposed to the first end defining a perimeter of the tray; and
a raised region disposed within the perimeter of the tray wherein the first end comprises a male extension and the second end comprises a female extension;
wherein the male extension and female extension are configured to snap together between two adjacent trays.

2. The tray of claim 1, wherein at least a portion of an outer surface of a male extension on a first tray is configured to slidingly engage at least a portion of an inner surface of a female extension on a second adjacent tray.

3. The tray of claim 2, wherein the female extension comprises a locking channel configured to engage a complementary ridge on the male extension.

4. The tray of claim 1, wherein the raised region of the tray comprises
a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges.

5. The tray of claim 1, wherein
the plurality of alternating parallel ridges comprise top surfaces defining a level plane for supporting one or more individual growing containers for containing growth medium and plants, and
the plurality of valleys slope downward from a peak to a gutter proximate to the perimeter of the tray, the one or more of the plurality of valleys are in fluid communication with the gutter for channeling fluid collected into the gutter.

6. The tray of claim 1, wherein at least a portion of the first side wall is configured to engage a top of a first elongate side support member and at least a portion of the second side wall is configured to engage a top of a second elongate side support member.

7. The tray of claim 6, wherein
at least a portion of the first side wall is engaged with the top of the first elongate side support member and at least a portion of the second side wall is engaged with the top of the second elongate side support member; and
a bottom panel is engaged between the first and second elongate side members;
wherein the tray, the first and second elongate side members and the bottom panel define an air passage.

8. The tray of claim 7, wherein the raised region of the tray comprises
a plurality of alternating parallel ridges disposed between the side walls and a plurality of valleys formed between adjacent ridges of the plurality of ridges, wherein one or more of the plurality of valleys are in fluid communication with a gutter; and optionally
one or more of a plurality of holes in one or more of the plurality of ridges.

9. The tray of claim 8 wherein the bottom panel optionally comprises a plurality of orifices to direct air from the air passage.

10. The tray of claim 7 wherein the air passage comprises an elongated duct assembly having a first end in fluid communication with an outlet opening of a fan assembly, a second end opposed to the first end configured to be either closed or in fluid communication with a second duct assembly, and a plurality of orifices or a plurality of holes in the one or more air passages to distribute air out of the one or more air passages.

11. The tray of claim 10 wherein the plurality of orifices or the plurality of holes are configured to
direct air from the duct assembly to above the duct assembly; or
direct air from the duct assembly to below the duct assembly; or
direct air from the duct assembly to above and below the duct assembly.

12. A duct assembly comprising a tray of claim 1 wherein
at least a portion of the first side wall is engaged with the top of the first elongate side support member and at least a portion of the second side wall is engaged with the top of the second elongate side support member; and
a bottom panel is engaged between the first and second elongate side members;
wherein the tray, the first and second elongate side members and the bottom panel define one or more air passages.

13. The duct assembly of claim 12, wherein at least a portion of an outer surface of a male extension on a first tray is configured to slidingly engage at least a portion of an inner surface of a female extension on a second adjacent tray.

14. The duct assembly of claim 13, wherein the female extension comprises a locking channel configured to engage a complementary ridge on the male extension.

15. The duct assembly of claim 12 further comprising a center support member engaged to a first and second bottom panel and the bottom surface of the tray to define two air passages in the duct assembly.

16. The duct assembly of claim 12, wherein the raised region of the tray comprises
a plurality of alternating parallel ridges disposed between the side walls and a plurality of valleys formed between adjacent ridges of the plurality of ridges, wherein one or more of the plurality of valleys are in fluid communication with a gutter; and optionally
one or more of a plurality of holes in one or more of the plurality of ridges.

17. The duct assembly of claim 16, wherein
the plurality of alternating parallel ridges comprise top surfaces defining a level plane for supporting one or more individual growing containers for containing growth medium and plants, and
the plurality of valleys slope downward from a peak to the gutter proximate to the perimeter of the tray, the one or more of the plurality of valleys are in fluid communication with the gutter for channeling fluid collected into the gutter.

18. The duct assembly of claim 12, wherein the raised region of the tray comprises one or more of a plurality of holes in one or more of the plurality of ridges.

19. The duct assembly of claim 12 wherein the bottom panel comprises a plurality of orifices to direct air from the air passage.

20. The duct assembly of claim 12 wherein the air passage comprises a first end in fluid communication with an outlet opening of a fan assembly, a second end opposed to the first end configured to be either closed or in fluid communication with a second duct assembly, and a plurality of orifices or a plurality of holes in the one or more air passages to distribute air out of the one or more air passages.

21. The duct assembly of claim 20 wherein the plurality of orifices or the plurality of holes are configured to
direct air from the duct assembly to above the duct assembly; or
direct air from the duct assembly to below the duct assembly; or
direct air from the duct assembly to above and below the duct assembly.
